(19) United States
(12) Patent Application Publication
(10) Pub. No.: US 2007/0263746 A1
(43) Pub. Date: Nov. 15, 2007

(54) Feedback frame structure for subspace tracking precoding

(75) Inventor: Jae Son, Irving, TX (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/800,709

(22) Filed: May 7, 2007

Related U.S. Application Data
(60) Provisional application No. 60/799,811, filed on May 12, 2006.

(51) Int. Cl. H04L 1/02; H04L 27/00; H04B 7/02

(52) U.S. Cl. 375/267; 375/299; 375/347

(57) ABSTRACT

The specification and drawings present a new method, system, apparatus and software product for resolving a feedback frame structure for implementing subspace tracking precoding for a MIMO-OFDM system, e.g., a wireless communication system. An efficient feedback frame format is generated by a receiver using a predetermined criterion and deciphered (decoded) by a transmitter when a subspace tracking preceding beamforming scheme is implemented.

### PRIORITY AND CROSS-REFERENCE TO RELATED APPLICATION

This application claims priority from U.S. Provisional Application Ser. No. 60/799,811, filed on May 12, 2006.

### TECHNICAL FIELD

This invention generally relates to communications and more specifically to resolving a feedback frame structure for implementing subspace tracking preceding for a MIMO-OFDM system, e.g., a wireless communication system.

### BACKGROUND ART

It is well-known that a MIMO (multiple input multiple output) beamforming scheme can provide both spatial diversity and array gains thus enabling increased system capacity/throughput. However, providing accurate feedback information such as MIMO channel state information or beamforming matrices can be difficult and costly in terms of feedback bandwidth allocation and hardware computational complexity. As an alternative solution to overcome these practical implementation issues, a MIMO preceding system with limited feedback is often proposed where an index of a precoding matrix codebook is a feedback to the transmitter instead of a beamforming matrix (e.g., see David J. Love, Robert W. Heath Jr., and Thomas Strohmer, “Grassmannian Beamforming for Multiple-Input Multiple-Output Wireless Systems”, IEEE Trans. Information Theory, Vol. 49, No. 10, October 2003, pp. 2735-2747). Further, by exploiting the channel coherence bandwidth characteristics of a MIMO-OFDM (orthogonal frequency division multiplexing) system, a subspace tracking method can be used to further reduce the feedback index bits and preceding matrix selection computation (e.g., see Nico VanWaes, Hua Zang, Juha Hiiskala and Victor Stolpman, etc, “System and Method for Precoding in a Multiple-Input Multiple0Output (MIMO) System”, PCT Patent Application published as WO 2006/018710, and Anthony Reid and Jianzhong Zhzng “Hochwald Construction of Unitary Matrix Codebooks via Eigen Coordinate Transformations”, WO 2006/075220.

Usually, a beamforming (or closed-loop) system requires some form of feedback information from a receiver to a transmitter. The conventional beamforming (for example Eigen beamforming) requires channel state information matrices or beamforming matrices to be sent back. This type of feedback information requires parameters specifying the row and column size of feedback matrices, a subcarrier grouping size (or a cluster size) and a quantization bit size and an array of actual quantized data elements starting in the order of the lowest subcarrier index to the highest subcarrier index (e.g., see IEEE Std 802.11n MAC/PHY Specifications D0.04, March 2006). For a conventional precoding beamforming, it would be possible to reduce this feedback information by replacing beamforming matrices contents with precoding matrix codebook indices (e.g., see IEEE Std 802.16e MAC/PHY Specifications D12, 2005). However, with the new subspace tracking preceding method, it is necessary to define its own efficient feedback frame structure apart from the conventional preceding feedback frame structure.

### DISCLOSURE OF THE INVENTION

According to a first aspect of the invention, a method, comprises: providing by a receiving component a feedback signal having a pre-defined frame structure for implementing subspace tracking preceding, wherein the pre-defined frame structure comprises parameters defined using a predetermined criterion, the parameters comprise: control field parameters comprising: information on a subspace preceding tracking table formed using a preceding matrix codebook with pre-defined codewords for a precoding matrices of a selected size, and data field parameters comprising: a precoding matrix index for one cluster, the precoding matrix index defining a precoding matrix for the one cluster and being selected from the precoding matrix codebook, one or more precoding matrix indexes for corresponding one or more further clusters, the one or more preceding matrix indexes defining preceding matrices for the one or more further clusters and being selected, using the information, from the subspace precoding tracking table by using a reduced number of codewords of the pre-defined codewords comprised in the subspace precoding tracking table.

According further to the first aspect of the invention, the a number of the one or more preceding matrix indexes may be equal to:

$$K = ⌊ \frac{{N}_{BR}}{{N}_{g}} ⌋ - 1 ,$$

wherein operator └x┘ rounds x towards −∞, i.e., integer such that x−1<└x┘≦x, N_{BR} is a total number of beamformed sub-carriers and N_{g} is a size of the one cluster and of the one or more further clusters, the N_{g} being defined by one or more beamformed sub-carriers of a plurality of beamformed sub-carriers.

Further according to the first aspect of the invention, a number of bits in the feedback signal identifying the precoding matrix index may be larger than a further number of bits identifying any of the one or more preceding matrix indexes.

Still further according to the first aspect of the invention, the control field parameters may further comprise a selected size of the preceding matrices indicated by a number of columns and rows in the precoding matrices. Still yet further, the number of columns in the precoding matrices may be equal to a number of spatial streams for each of the one cluster and the one or more further clusters, the number of rows in the precoding matrices may be equal to a number of transmitter antennas for each of the one cluster and the one or more further clusters, and the number of spatial streams may be equal or less than the number of the transmitter antennas.

According still further to the first aspect of the invention, the control field parameters may further comprise a cluster size indicating a number of sub-carriers in each of the one cluster and the one or more further clusters, the number of sub-carriers being one or more sub-carriers out of a plurality of beamformed sub-carriers.

According further still to the first aspect of the invention, the method may further comprise: transmitting the feedback signal to a transmitting component for generating symbol vectors using preceding matrixes corresponding to the one cluster and the one or more further clusters using the control field and data field parameters.

According further to the first aspect of the invention, the feedback frame structure may be generated by the receiving component using received signals generated by receiving antennas comprised in the receiving component.

According yet further still to the first aspect of the invention, the information on the subspace precoding tracking table may comprise at least one of: a subspace tracking size and an index of the subspace precoding tracking table. Yet still further, the preceding matrix index may have a number of bits given by log₂ of a size of the precoding matrices and the one or more preceding matrix indexes may have a number of bits given by log₂ of the subspace tracking size.

Yet still further according to the first aspect of the invention, prior to the providing, the method may comprise: receiving a plurality of spatial data streams by the receiving component; performing channel estimation by the receiving component using the plurality of spatial data streams; determining the control field and data field parameters for the subspace tracking precoding using the channel estimation and the predetermined criterion; and generating the feedback signal by the receiving component.

Still yet further according to the first aspect of the invention, the control field parameters may further comprise an identification of a preceding matrix codebook, the identification being at least one of: a size of the precoding matrix codebook and an index of the precoding matrix codebook.

According to a second aspect of the invention, a computer program product comprises: a computer readable storage structure embodying computer program code thereon for execution by a computer processor with the computer program code, wherein the computer program code comprises instructions for performing the method of the first aspect of invention, indicated as being performed by any component or a combination of components of the receiving component.

According to a third aspect of the invention, a method, comprises: receiving by a transmitting component a feedback signal having a pre-defined frame structure for implementing subspace tracking precoding, wherein the pre-defined frame structure comprises parameters defined using a predetermined criterion, the parameters comprise: control field parameters comprising: information on a subspace precoding tracking table formed using a precoding matrix codebook with pre-defined codewords for a preceding matrices of a selected size, and data field parameters comprising: a precoding matrix index for one cluster, the precoding matrix index defining a preceding matrix for the one cluster and being selected from the preceding matrix codebook, one or more precoding matrix indexes for corresponding one or more further clusters, the one or more precoding matrix indexes defining precoding matrices for the one or more further clusters and being selected, using the information, from the subspace precoding tracking table by using a reduced number of codewords of the pre-defined codewords comprised in the subspace precoding tracking table; and generating by the transmitting component the preceding matrix corresponding to the one cluster and to the one or more further clusters using the control field and data field parameters.

According further to the third aspect of the invention, the method may further comprise: generating by the transmitter component symbol vectors using the precoding matrices corresponding to the one cluster and the one or more further clusters using the control field and data field parameters; and transmitting the symbol vectors using transmitting antennas comprised in the transmitter component.

Further according to the third aspect of the invention, a number of the one or more preceding matrix indexes may be equal to:

$$K = ⌊ \frac{{N}_{BR}}{{N}_{g}} ⌋ - 1 ,$$

wherein operator └x┘ rounds x towards −∞, i.e., integer such that x−1<└x┘≦x, N_{BR} is a total number of beam formed sub-carriers and N_{g} is a size of the one cluster and of the one or more further clusters, the N_{g} being defined by one or more beamformed sub-carriers of a plurality of beamformed sub-carriers.

Still further according to the third aspect of the invention, the control field parameters may further comprise at least one of: a selected size of the precoding matrices indicated by a number of columns and rows in the precoding matrices, and a cluster size indicating a number of sub-carriers in each of the one cluster and the one or more further clusters, the number of sub-carriers being one or more sub-carriers out of a plurality of beamformed sub-carriers.

According further to the third aspect of the invention, the information on the subspace preceding tracking table may comprise at least one of: a subspace tracking size and an index of the subspace precoding tracking table.

According still further to the third aspect of the invention, the control field parameters may further comprise an identification of a preceding matrix codebook, the identification being at least one of: a size of the precoding matrix codebook and an index of the precoding matrix codebook.

According to a fourth aspect of the invention, a computer program product comprises: a computer readable storage structure embodying computer program code thereon for execution by a computer processor with the computer program code, wherein the computer program code comprises instructions for performing the method of the third aspect of invention, indicated as being performed by any component or a combination of components of the transmitting component.

According to a fifth aspect of the invention, a receiving component, comprises: a feedback frame generating module, configured to provide a feedback signal having a pre-defined frame structure for implementing subspace tracking preceding, wherein the pre-defined frame structure comprises parameters defined using a predetermined criterion, the parameters comprise: control field parameters comprising: information on a subspace precoding tracking table formed using a precoding matrix codebook with pre-defined codewords for a preceding matrices of a selected size, and data field parameters comprising: a precoding matrix index for one cluster, the precoding matrix index defining a precoding matrix for the one cluster and being selected from the precoding matrix codebook, one or more precoding matrix indexes for corresponding one or more further clusters, the one or more precoding matrix indexes defining precoding matrices for the one or more further clusters and being selected, using the information, from the subspace preceding tracking table by using a reduced number of codewords of the pre-defined codewords comprised in the subspace preceding tracking table.

According further to the fifth aspect of the invention, the receiving component may further comprise: a transmitter configured to transmit the feedback signal to a transmitting component for generating symbol vectors using preceding matrices corresponding to the one cluster and the one or more further clusters using the control field and data field parameters.

Further according to the fifth aspect of the invention, a number of the one or more precoding matrix indexes may be equal to:

$$K = ⌊ \frac{{N}_{BR}}{{N}_{g}} ⌋ - 1 ,$$

wherein operator └x┘ rounds x towards −∞, i.e., integer such that x−1<└x┘≦x, N_{BR} is a total number of beamformed sub-carriers and N_{g} is a size of the one cluster and of the one or more further clusters, the N_{g} being defined by one or more beamformed sub-carriers of a plurality of beamformed sub-carriers.

Still further according to the fifth aspect of the invention, a number of bits in the feedback signal identifying the precoding matrix index may be larger than a further number of bits identifying any of the one or more precoding matrix indexes.

According further to the fifth aspect of the invention, the control field parameters further may comprise a selected size of the precoding matrices indicated by a number of columns and rows in the precoding matrices. Yet further, the number of columns in the precoding matrices may be equal to a number of spatial streams for each of the one cluster and the one or more further clusters, the number of rows in the precoding matrices may be equal to a number of transmitter antennas for each of the one cluster and the one or more further clusters, and the number of spatial streams may be equal or less than the number of transmitter antennas.

According still further to the fifth aspect of the invention, the control field parameters may further comprise a cluster size indicating a number of sub-carriers in each of the one cluster and the one or more further clusters, the number of sub-carriers being one or more sub-carriers out of a plurality of beamformed sub-carriers.

According further still to fifth aspect of the invention, the feedback frame structure may be generated by the receiving component using received signals generated by receiving antennas comprised in the receiving component.

Yet still further according to the fifth aspect of the invention, the information on the subspace precoding tracking table may comprise at least one of: a subspace tracking size and an index of the subspace preceding tracking table. Still further, the precoding matrix index may have a number of bits given by log₂ of a size of the precoding matrices and the one or more precoding matrix indexes may have a number of bits given by log₂ of the subspace tracking size.

Still yet further according to the fifth aspect of the invention, the receiving component may further comprise: receiving antennas configured to receive a plurality of spatial data streams; a channel estimation module configured to perform channel estimation using the plurality of spatial data streams; wherein the feedback frame generating module is configured to determine the control field and data field parameters for the subspace tracking precoding using the channel estimation and the predetermined criterion for generating the feedback signal.

Still further still according to the fifth aspect of the invention, the control field parameters may further comprise an identification of a precoding matrix codebook, the identification being at least one of: a size of the precoding matrix codebook and an index of the precoding matrix codebook.

According to a sixth aspect of the invention, a transmitting component, comprises: a receiver, configured to receive a feedback signal having a pre-defined frame structure for implementing subspace tracking precoding, wherein the pre-defined frame structure comprises parameters defined using a predetermined criterion, the parameters comprise: control field parameters comprising: information on a subspace precoding tracking table formed using a precoding matrix codebook with pre-defined codewords for a precoding matrices of a selected size, and data field parameters comprising: a precoding matrix index for one cluster, the precoding matrix index defining a precoding matrix for the one cluster and being selected from the precoding matrix codebook, one or more precoding matrix indexes for corresponding one or more further clusters, the one or more precoding matrix indexes defining precoding matrices for the one or more further clusters and being selected, using the information, from the subspace precoding tracking table by using a reduced number of codewords of the pre-defined codewords comprised in the subspace precoding tracking table; and a precoding matrix defining module configured to generate the precoding matrices corresponding to the one cluster and to the one or more further clusters using the control field and data field parameters.

According further to the sixth aspect of the invention, the transmitting component may further comprise: a precoder configured to define symbol vectors using the preceding matrices corresponding to the one cluster and the one or more further clusters using the control field and data field parameters; and transmitting antennas configured to transmit the symbol vectors.

Further according to the sixth aspect of the invention, a number of the one or more precoding matrix indexes may be equal to:

$$K = ⌊ \frac{{N}_{BR}}{{N}_{g}} ⌋ - 1 ,$$

wherein operator └x┘ rounds x towards −∞, i.e., integer such that x−1<└x┘≦x, N_{BR} is a total number of beamformed sub-carriers and N_{g} is a size of the one cluster and of the one or more further clusters, the N_{g} being defined by one or more beamformed sub-carriers of a plurality of beamformed sub-carriers.

Still further according to the sixth aspect of the invention, the control field parameters may further comprise at least one of: a selected size of the precoding matrices indicated by a number of columns and rows in the preceding matrices, and a cluster size indicating a number of sub-carriers in each of the one cluster and the one or more further clusters, the number of sub-carriers being one or more sub-carriers out of a plurality of beamformed sub-carriers.

According further to the sixth aspect of the invention, the information on the subspace preceding tracking table may comprise at least one of: a subspace tracking size and an index of the subspace precoding tracking table.

According still further to the sixth aspect of the invention, the control field parameters may further comprise an identification of a precoding matrix codebook, the identification being at least one of: a size of the preceding matrix codebook and an index of the preceding matrix codebook.

### BRIEF DESCRIPTION OF THE DRAWINGS

FIG. 1 is a schematic representation of the overall feedback frame structure of subspace tracking precoding beamforming, according to an embodiment of the present invention;

FIG. 2 is a an exemplary table of control and data field parameter information, according to an embodiment of the present invention;

FIG. 3 is a schematic representation of an example illustrating the feedback frame structure generation, according to an embodiment of the present invention;

FIG. 4 is a block diagram for providing a feedback signal comprising a pre-defined frame structure for implementing subspace tracking precoding, according to an embodiment of the present invention; and

FIG. 5 is a flow chart for providing a feedback signal comprising a pre-defined frame structure for implementing subspace tracking precoding, according to an embodiment of the present invention.

### MODES FOR CARRYING OUT THE INVENTION

A new method, system, apparatus and software product are presented for resolving a feedback frame structure for implementing subspace tracking preceding for a MIMO (multiple input multiple output)-OFDM (orthogonal frequency division multiplexing) system, e.g., a wireless communication system. Various embodiments of the present invention describe an efficient feedback frame format to be generated by a receiver using a predetermined criterion and deciphered (decoded) by a transmitter when a subspace tracking preceding beamforming scheme is implemented.

A conventional MIMO-OFDM precoding scheme can be based on an independent preceding scheme between adjacent sub-carriers/clusters (the cluster can comprise or grouped to one or more sub-carriers). However, it is often the case that there must be some channel correlation among adjacent subcarriers due to channel coherence bandwidth. This idea can be exploited for the precoding matrix selection process of the adjacent subcarrier/cluster. In other words, the preceding matrix of a subcarrier/cluster k+1 can be found from a subset of the codebook (or in the vicinity of the preceding matrix of a subcarrier/cluster k). This subset precoding selection concept (as called subspace tracking) can enable a smaller search space within the original codebook space, thus requiring a less number of bits to identify its selection index and a less number of precoding matrices search computation. With this subspace tracking method, the total number of feedback bits per cluster can be further reduced to log₂N_{SSI} where N_{SSI} is the subspace tracking size and N_{SSI}<L (L is a size of codebook with L codewords). In addition, these subspace elements can be pre-determined once a precoding matrix codebook is identified. A simple and effective subspace tracking table can be constructed based on the following metric:

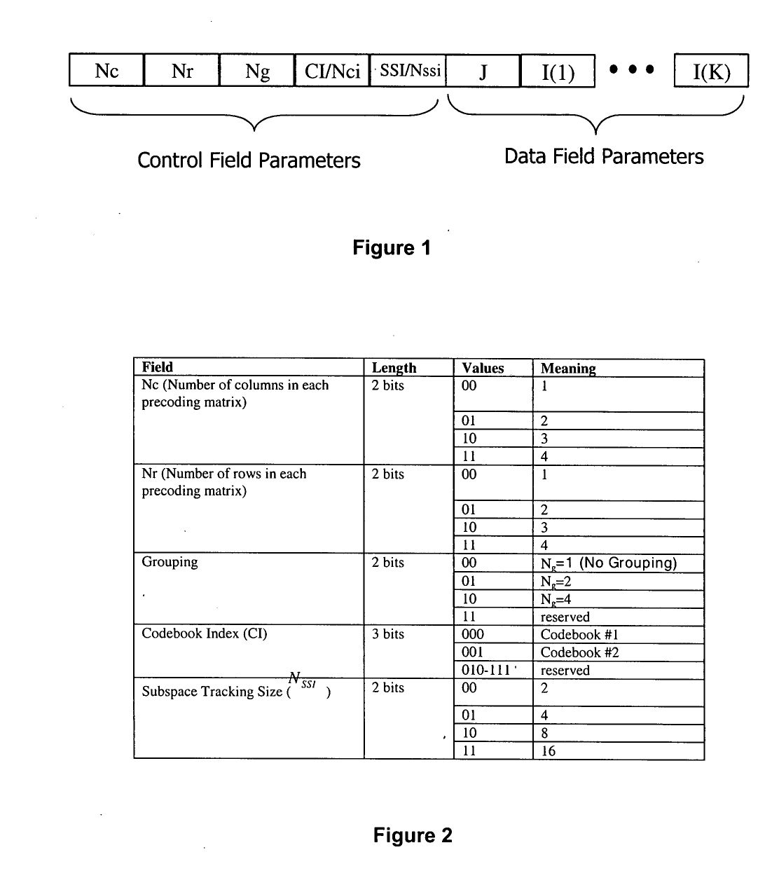

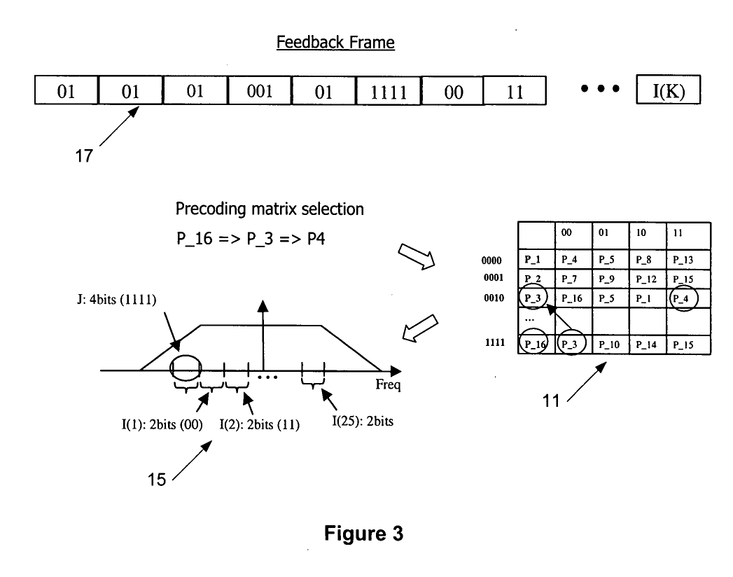

Γ(l,k)=abs(N_{c}−trace{Qₗ^{H}Qₖ})1≦l≦L, 1≦k≦L (1)

wherein l represents the row index of the subspace tracking table, Qₗ is the lth preceding matrix in the codebook, and N_{c} is the number of spatial streams. For the lth row of the subspace tracking table, first, Γ(l,k) for 1≦k≦L values are obtained and then sorted by an ascending order. Each row of the subspace tracking table will be filled with the first N_{SSI} indices among L sorted indices in the ascending order. This table construction procedure continues for all rows of the subspace tacking table. Note that the column index of the subspace tracking table (ranging from 0 to 2^{N}^{_{SSI}}−1) constitutes a subspace tracking feedback index such as I(1), 1(2), . . . , I(K) as shown in FIG. 1 as discussed herein. An example of subspace tracking table constructed using this algorithm is shown in FIG. 3.

For a subspace tracking preceding, the feedback frame structure can be formatted by a vector structure described in an example below, according to an embodiment of the present invention. However, some modification of this frame structure is possible due to the omission of some parameters for its redundancy and due to a different parameter order. The example among others of the vector structure can be described as follows as shown in FIG. 1, which comprises:

Control Field Parameters:
N_{c} can specify a number of columns in the precoding matrix (e.g., a number of spatial streams for each cluster),
N_{Γ} can specify a number of rows in the precoding matrix (e.g., a number of transmitter antennas for each cluster); in general the number of the spatial streams could be equal or less than the number of transmitter antennas,
N_{g} can specify a cluster (grouping) size (i.e., a number of sub-carriers in one cluster, wherein the cluster can comprise or grouped to one or more sub-carriers); the grouping N_{g} indicates the number of subsequent carriers for which a single feedback value is provided which is equivalent to how many adjacent subcarriers are being beamformed by each selected precoding matrix,
CI can specify (or identify) a precoding matrix codebook selection; instead or in addition, N_{ci} can specify a preceding matrix codebook size, and
SSI can specify a subspace precoding tracking table selection; instead or in addition, N_{SSI} can specify a subspace tracking size; it is noted that information on the subspace preceding tracking table selection by itself can comprise all information needed for the transmitter to decipher (decode) in order to generate symbol vectors using preceding matrices (i.e., the corresponding selected subspace preceding tracking table with pre-selected N_{c}, N_{Γ}, N_{g}, CI/N_{ci}, can be known to the transmitter); and

Data Field Parameters:
J can specify a precoding matrix index for the first cluster, which is based on the selected preceding matrix codebook; J can be log2(L) bits long wherein L is the selected codebook size,
I(1) bits can specify a subspace tracking table index (or preceding matrix index) for the second cluster, which is based on the column index of the subspace tracking table; I(1) would be log2(N_{SSI}) bits long, and
I(k) bits can specify the subspace tracking table index for the k+1th cluster, wherein k=2, . . . K, K being total number of the subspace tracking table indexes.

Thus the Quantized Precoding Matrices Feedback Information field contains the index of a preceding matrix codebook and the indexes of a subspace tracking table, which are indexed in order (lowest frequency index first) by a group of data subcarriers index as depicted in FIGS. 1 and 2.

It is noted that a number of bits identifying the precoding matrix index J generally can be larger than a number of bits identifying any of the precoding matrix indexes I(1), I(2), (k), . . . I(K), wherein the total number of the subspace tracking table indeces K can be determined by the number of beamformed subcarriers N_{BF} and a grouping (cluster) N_{g} size as follows

$$K = ⌊ \frac{{N}_{BF}}{{N}_{g}} ⌋ - 1 , \qquad ( 2 )$$

wherein operator └x┘ rounds x towards −∞, i.e., integer such that x−1<└x┘≦x.

The example shown in FIG. 1 illustrates the general usage of the feedback frame structure. However, depending on a particular design of a subspace tracking precoding method, it is possible to implement feedback parameters less than those parameters as shown in FIG. 1.

FIG. 2 shows an example among others of a table specifying the control and data field parameters of the feedback frame, according to an embodiment of the present invention. FIG. 3 shows an example among others illustrating the feedback frame structure generation feedback frame based on the feedback frame structure shown in FIG. 1. Based on the table entry of FIG. 2 and the parameter values of the feedback frame shown on the top table 17 in FIG. 3, the following information can be obtained. The precoding matrix may be a 2×2 matrix. The subcarrier cluster size may be 2. The precoding matrix may be found from a codebook #2, and the subspace tracking size may be 4. In this example, it can be assumed that the codebook #2 has the codebook size L equal to 16. If 52 beamformed subcarriers per OFDM symbol are used, then there would be 26 clusters.

For the first subcarrier cluster, the first index, J, is the index of a selected preceding matrix from the codebook search. The exact selection methodology can depend on implementation, but it can be based on well-known performance metrics such as mean square errors (MSE), a system capacity, SNR (signal-to-noise ratio), etc. The first cluster preceding matrix would be found from the precoding matrix codebook #2 and its feedback index J would require log₂(L)=4 bits long.

The rest of the indexes, I(1), . . . , I(K), represent the column indices of the subspace tracking table that can be obtained using a similar selection methodology. The row index of the subspace tracking table represents the precoding matrix index in the codebook, and its column size is based on the subspace tracking size N_{SSI}: the feedback indexes would then only require log₂(N_{SSI})=2 bits for the example of FIG. 3, wherein N_{SSI}=4). The content of the subspace precoding tracking table 11 comprises the indexes of a precoding matrix codebook. Each subspace tracking feedback index is determined by the codebook index of the previous precoding matrix and the subspace tracking table. The index value of the previous precoding matrix points the row of the subspace precoding tracking table 11 to be examined. The codebook index contents in that row specify precoding matrices to be selected from. When a desirable precoding matrix is found based on a predetermined selection criteria, instead of sending the actual codebook index of the selected precoding matrix, the table column index of the selected precoding matrix will be sent as the feedback index. This procedure continues for the rest of subcarrier clusters as elaborated further below.

Based on some precoding matrix selection metric (such as MSE, capacity, etc.), a precoding matrix P₁₆ can be chosen as a precoding matrix for the first sub-carrier cluster as shown in FIG. 3. Thus, the first feedback index, J, will be 1111. Next, an adjacent precoding matrix index will be found from the subspace precoding tracking table 11 as shown on the right in FIG. 3. Since the previous matrix selection is P₁₆, the precoding matrix for the second subcarrier cluster would be found among [P₃, P₁₀, P₁₄, P₁₅] which can be selected from the 16^{th} row of the subspace precoding tracking table 11. If P₃ was selected for the precoding matrix of the second subcarrier cluster, then the feedback index, I(1), would be 00 which is the column index of the table 11. This in turn indicates that the precoding matrix of the third cluster can be found from the third row of the subspace precoding tracking table 11. Again, if P₄ was selected based on a selection algorithm (a predetermined criterion), then the feedback index of the third subcarrier cluster, I(2), would be 11. This procedure can continue for the rest of the subcarrier clusters, and the data field of the feedback frame can be constructed accordingly as shown on the graph 15 on the bottom of FIG. 3

K can be determined by the number of beamformed subcarriers, N_{BF} using Equation 2, whereas the size of the Quantized Precoding Matrices Feedback Information field can be found as log₂ L+K log₂ N_{SSI} bits (if it is not integer multiples of byte, then the field is padded to the next byte boundary).

It is further noted that for the above example implemented in 2×2 MIMO configurations, the total number of feedback bits required for the subspace precoding method is 4+25×2=54 bits. However, for an Eigen beamforming method with 8 bits quantization, it would require 2×2×2×8×26=1664 bits. For implementation complexity, the example with the proposed subspace precoding method will require

$$( \frac{16 + 4 \times 25}{26} ) \times {2}^{3} \approx 36$$

complex multiplications per cluster if Qₗ^{H}H(k) 1≦l≦L based selection algorithm is used (see Equation 1). On the other hand, the Eigen beamforming will require 12×2³=96 complex multiplications. This shows that the subspace precoding method, described herein, can provide more than 60% implementation complexity reduction compared to the Eigen beamforming method.

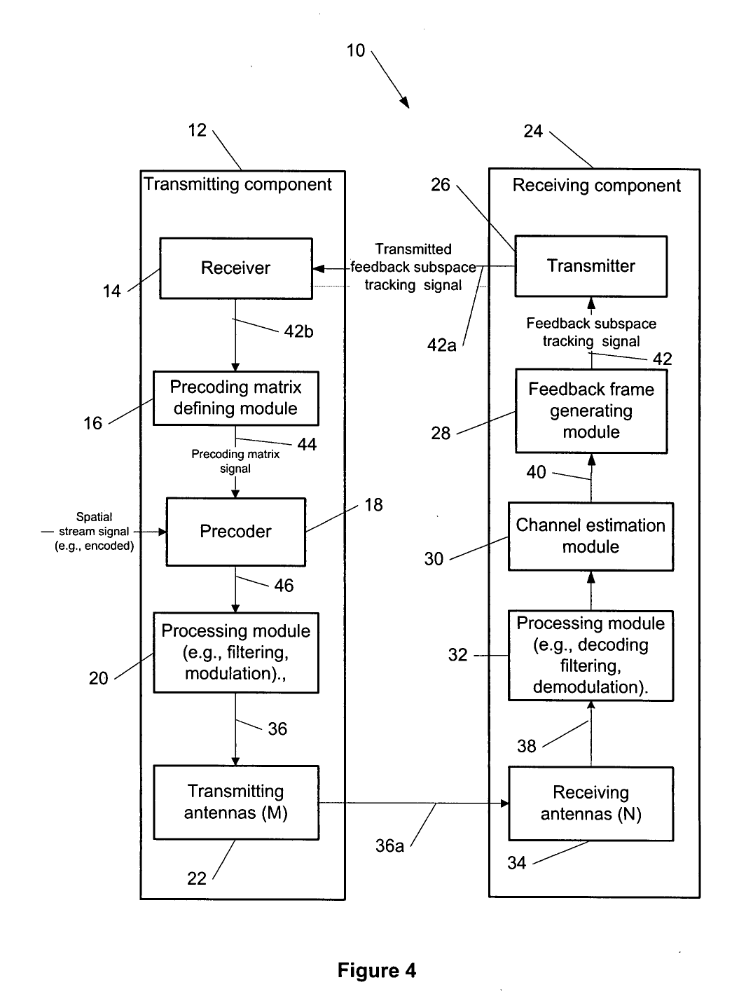

FIG. 4 is example among others of a block diagram for providing a feedback signal comprising a pre-defined frame structure by a receiving component 24 for implementing subspace tracking preceding by a transmitting component 12 in a communication system 10, according to an embodiment of the present invention.

In the example of FIG. 4, a receiver component 24 can comprise receiving antennas 34, a processing module 32, a channel estimation module 30, a feedback frame generating module 28 and a transmitter 26, whereas a transmitter component 12 can comprise transmitting antennas 22, a processing module 20, a precoder 18, a precoding matrix defining module 16 and a receiver 14. Components 24 and 12 can be, for example, user equipment, base station or sub-carrier station, Node B, or other network elements, etc.

After receiving a plurality of spatial data streams shown as a signal 36a from the transmitting component 12 by the receiving antenna 34 of the said receiving component 24, the signal is going through a standard processing (e.g., decoding filtering, demodulation, etc.) performed by the module 32 and then provided (as a signal 38) to a channel estimation module 30. The module 30 can perform channel estimation (as known in the art) using the plurality of spatial data streams comprised in the signal 36a which is provided (as a signal 40) to the feedback frame generating module 28. The module 28 determines the control field and data field parameters for the subspace tracking precoding based on the channel estimation and using the predetermined criterion, and forms the feedback subspace tracking signal 42 with the pre-defined frame structure according to various embodiments of the present invention described herein. The signal 42 is transmitted by the transmitter 26 as a signal 42a to the receiver 14 of the transmitting component 14 which is then forwarded as a signal 42b to the preceding matrix defining module 16.

After receiving the pre-defined frame structure, the precoding matrix defining module 16 generates the precoding matrices corresponding to all clusters (or sub-carriers) using (i.e., by deciphering or decoding) the control field and data field parameters comprised in the signal 42 and provides a preceding matrix signal 44 comprising said deciphered precoding matrices to the precoder 18. The precoder 18 then uses the precoding matrix signal 44 for generating symbol vectors using the deciphered preceding matrices for corresponding clusters and provides the spatial data streams signal 36 comprising said symbol vectors to the transmitting antennas 22 which re-send the signal 36 to the receiving component 24.

According to an embodiment of the present invention, various modules of the receiving or transmitting components 24 or 12 can be implemented as a software or a hardware block or a combination thereof. Furthermore, the module 28, 30, 16 or 18 (as well as other modules of the receiving and transmitting components 24 or 12) can be implemented as a separate module or can be combined with any other standard module/block or it can be split into several blocks according to their functionality. All or selected modules of the receiving components 24 can be implemented using an integrated circuit, and all or selected modules of the transmitting components 12 can be implemented using an integrated circuit as well.

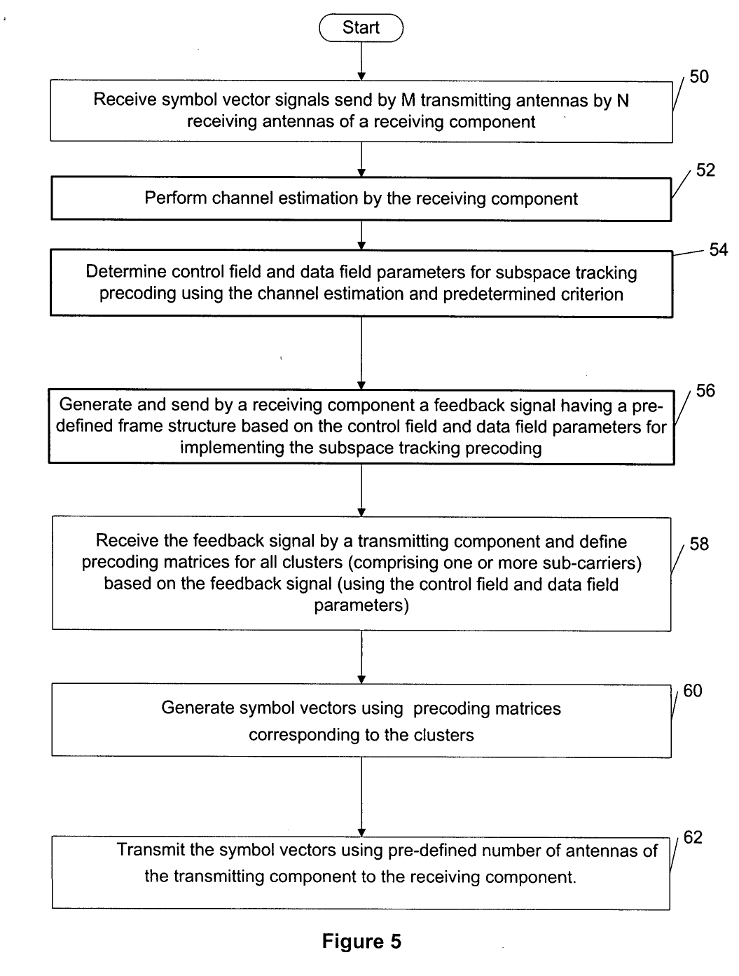

FIG. 5 is a flow chart for providing a feedback signal comprising a pre-defined frame structure for implementing subspace tracking preceding, according to an embodiment of the present invention.

The flow chart of FIG. 5 only represents one possible scenario among others. The order of steps shown in FIG. 5 is not absolutely required, so generally, the various steps can be performed out of order. In a method according to an embodiment of the present invention, in a first step 50, N receiving antennas of a receiving component receive symbol vector signals send by M transmitting antennas of a transmitting component. In a next step 52, channel estimation is performed by the receiving component. In a next step 54, control field and data field parameters are determined for subspace tracking precoding using said channel estimation and a predetermined criterion, according to embodiments of the present invention described herein. In a next step 56, a receiving component generates and sends a feedback signal having a pre-defined frame structure based on the control field and data field parameters for implementing the subspace tracking preceding.

In a next step 58, the transmitting component receives the feedback signal and defines precoding matrices for all clusters (comprising one or more sub-carriers) based on the feedback signal (using the control field and data field parameters). In a next step 60, the precoder of the transmitting component generates symbol vectors using said precoding matrices corresponding to the clusters. In a next step 62, the symbol vectors are transmitted using pre-defined number of antennas of the transmitting component to the receiving component.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

Also, it is noted that various embodiments of the present invention recited herein can be used separately, combined or selectively combined for specific applications.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
providing by a receiving component a feedback signal having a pre-defined frame structure for implementing subspace tracking precoding, wherein said pre-defined frame structure comprises parameters defined using a predetermined criterion, said parameters comprise:
control field parameters comprising:
information on a subspace precoding tracking table formed using a precoding matrix codebook with pre-defined codewords for a precoding matrices of a selected size, and
data field parameters comprising:
a precoding matrix index for one cluster, said precoding matrix index defining a preceding matrix for said one cluster and being selected from said precoding matrix codebook,
one or more precoding matrix indexes for corresponding one or more further clusters, said one or more precoding matrix indexes defining precoding matrices for said one or more further clusters and being selected, using said information, from said subspace precoding tracking table by using a reduced number of codewords of said pre-defined codewords comprised in said subspace precoding tracking table.

2. The method of claim 1, wherein a number of said one or more preceding matrix indexes equals to:
$$K = ⌊ \frac{{N}_{BR}}{{N}_{g}} ⌋ - 1 ,$$
wherein operator └x┘ rounds x towards −∞, i.e., integer such that x−1<└x┘≦x, N_{BR} is a total number of beamformed sub-carriers and N_{g} is a size of said one cluster and of the one or more further clusters, said N_{g} being defined by one or more beamformed sub-carriers of a plurality of beamformed sub-carriers.

3. The method of claim 1, wherein a number of bits in the feedback signal identifying said precoding matrix index is larger than a further number of bits identifying any of said one or more precoding matrix indexes.

4. The method of claim 1, wherein said control field parameters further comprise a selected size of the preceding matrices indicated by a number of columns and rows in said precoding matrices.

5. The method of claim 4, wherein said number of columns in said precoding matrices is equal to a number of spatial streams for each of said one cluster and said one or more further clusters, said number of rows in said preceding matrices is equal to a number of transmitter antennas for each of said one cluster and said one or more further clusters, and said number of spatial streams is equal or less than the number of the transmitter antennas.

6. The method of claim 1, wherein said control field parameters further comprise a cluster size indicating a number of sub-carriers in each of said one cluster and said one or more further clusters, said number of sub-carriers being one or more sub-carriers out of a plurality of beamformed sub-carriers.

7. The method of claim 1, wherein said method further comprising:
transmitting said feedback signal to a transmitting component for generating symbol vectors using preceding matrixes corresponding to said one cluster and said one or more further clusters using said control field and data field parameters.

8. The method of claim 1, wherein said feedback frame structure is generated by said receiving component using received signals generated by receiving antennas comprised in said receiving component.

9. The method of claim 1, wherein said information on the subspace precoding tracking table comprises at least one of: a subspace tracking size and an index of said subspace precoding tracking table.

10. The method of claim 9, wherein said precoding matrix index has a number of bits given by log₂ of a size of the precoding matrices and said one or more preceding matrix indexes have a number of bits given by log₂ of said subspace tracking size.

11. The method of claim 1, wherein prior to said providing, the method comprises:
receiving a plurality of spatial data streams by said receiving component;
performing channel estimation by said receiving component using said plurality of spatial data streams;
determining said control field and data field parameters for said subspace tracking precoding using said channel estimation and said predetermined criterion; and
generating said feedback signal by said receiving component.

12. The method of claim 1, wherein said control field parameters further comprise an identification of a precoding matrix codebook, said identification being at least one of: a size of said preceding matrix codebook and an index of said precoding matrix codebook.

13. A computer program product comprising: a computer readable storage structure embodying computer program code thereon for execution by a computer processor with said computer program code, wherein said computer program code comprises instructions for performing the method of claim 1, indicated as being performed by any module or a combination of modules of said receiving component.

14. A method, comprising:
receiving by a transmitting component a feedback signal having a pre-defined frame structure for implementing subspace tracking precoding, wherein said pre-defined frame structure comprises parameters defined using a predetermined criterion, said parameters comprise:
control field parameters comprising:
information on a subspace preceding tracking table formed using a precoding matrix codebook with pre-defined codewords for a precoding matrices of a selected size, and
data field parameters comprising:
a precoding matrix index for one cluster, said precoding matrix index defining a precoding matrix for said one cluster and being selected from said precoding matrix codebook,
one or more preceding matrix indexes for corresponding one or more further clusters, said one or more precoding matrix indexes defining precoding matrices for said one or more further clusters and being selected, using said information, from said subspace precoding tracking table by using a reduced number of codewords of said pre-defined codewords comprised in said subspace precoding tracking table; and
generating by said transmitting component said preceding matrix corresponding to said one cluster and to said one or more further clusters using said control field and data field parameters.

15. The method of claim 14, wherein said method further comprising:
generating by said transmitter component symbol vectors using said precoding matrices corresponding to said one cluster and said one or more further clusters using said control field and data field parameters; and
transmitting said symbol vectors using transmitting antennas comprised in said transmitter component.

16. The method of claim 14, wherein a number of said one or more precoding matrix indexes equals to:
$$K = ⌊ \frac{{N}_{BR}}{{N}_{g}} ⌋ - 1 ,$$
wherein operator └x┘ rounds x towards −∞, i.e., integer such that x−1<└x┘≦x, N_{BR} is a total number of beamformed sub-carriers and N_{g} is a size of said one cluster and of the one or more further clusters, said N_{g} being defined by one or more beamformed sub-carriers of a plurality of beamformed sub-carriers.

17. The method of claim 14, wherein said control field parameters further comprise at least one of:
a selected size of the preceding matrices indicated by a number of columns and rows in said preceding matrices, and
a cluster size indicating a number of sub-carriers in each of said one cluster and said one or more further clusters, said number of sub-carriers being one or more sub-carriers out of a plurality of beamformed sub-carriers.

18. The method of claim 14, wherein said information on the subspace precoding tracking table comprises at least one of: a subspace tracking size and an index of said subspace precoding tracking table.

19. The method of claim 14, wherein said control field parameters further comprise an identification of a preceding matrix codebook, said identification being at least one of: a size of said precoding matrix codebook and an index of said precoding matrix codebook.

20. A computer program product comprising: a computer readable storage structure embodying computer program code thereon for execution by a computer processor with said computer program code, wherein said computer program code comprises instructions for performing the method of claim 14, indicated as being performed by any module or a combination of modules of said transmitting component.

21. A receiving component, comprising:
a feedback frame generating module, configured to provide a feedback signal having a pre-defined frame structure for implementing subspace tracking preceding, wherein said pre-defined frame structure comprises parameters defined using a predetermined criterion, said parameters comprise:
control field parameters comprising:
information on a subspace precoding tracking table formed using a preceding matrix codebook with pre-defined codewords for a precoding matrices of a selected size, and
data field parameters comprising:
a preceding matrix index for one cluster, said precoding matrix index defining a precoding matrix for said one cluster and being selected from said precoding matrix codebook,
one or more preceding matrix indexes for corresponding one or more further clusters, said one or more precoding matrix indexes defining precoding matrices for said one or more further clusters and being selected, using said information, from said subspace precoding tracking table by using a reduced number of codewords of said pre-defined codewords comprised in said subspace precoding tracking table.

22. The receiving component of claim 21, further comprises:
a transmitter configured to transmit said feedback signal to a transmitting component for generating symbol vectors using preceding matrices corresponding to said one cluster and said one or more further clusters using said control field and data field parameters.

23. The receiving component of claim 21, wherein a number of said one or more preceding matrix indexes equals to:
$$K = ⌊ \frac{{N}_{BR}}{{N}_{g}} ⌋ - 1 ,$$
wherein operator └x┘ rounds x towards −∞, i.e., integer such that x−1<└x┘≦x, N_{BR} is a total number of beamformed sub-carriers and N_{g} is a size of said one cluster and of the one or more further clusters, said N_{g} being defined by one or more beamformed sub-carriers of a plurality of beamformed sub-carriers.

24. The receiving component of claim 21, wherein a number of bits in the feedback signal identifying said precoding matrix index is larger than a further number of bits identifying any of said one or more precoding matrix indexes.

25. The receiving component of claim 21, wherein said control field parameters further comprise a selected size of the precoding matrices indicated by a number of columns and rows in said precoding matrices.

26. The receiving component of claim 25, wherein said number of columns in said preceding matrices is equal to a number of spatial streams for each of said one cluster and said one or more further clusters, said number of rows in said precoding matrices is equal to a number of transmitter antennas for each of said one cluster, and said one or more further clusters and said number of spatial streams is equal or less than the number of transmitter antennas.

27. The receiving component of claim 21, wherein said control field parameters further comprise a cluster size indicating a number of sub-carriers in each of said one cluster and said one or more further clusters, said number of sub-carriers being one or more sub-carriers out of a plurality of beamformed sub-carriers.

28. The receiving component of claim 21, wherein said feedback frame structure is generated by said receiving component using received signals generated by receiving antennas comprised in said receiving component.

29. The receiving component of claim 21, wherein said information on the subspace precoding tracking table comprises at least one of: a subspace tracking size and an index of said subspace precoding tracking table.

30. The receiving component of claim 29, wherein said precoding matrix index has a number of bits given by log₂ of a size of the precoding matrices and said one or more precoding matrix indexes have a number of bits given by log₂ of said subspace tracking size.

31. The receiving component of claim 21, further comprising:
receiving antennas configured to receive a plurality of spatial data streams;
a channel estimation module configured to perform channel estimation using said plurality of spatial data streams; wherein
said feedback frame generating module is configured to determine said control field and data field parameters for said subspace tracking precoding using said channel estimation and said predetermined criterion for generating said feedback signal.

32. The receiving component of claim 21, wherein said control field parameters further comprise an identification of a precoding matrix codebook, said identification being at least one of: a size of said precoding matrix codebook and an index of said precoding matrix codebook.

33. A transmitting component, comprising:
a receiver, configured to receive a feedback signal having a pre-defined frame structure for implementing subspace tracking preceding, wherein said pre-defined frame structure comprises parameters defined using a predetermined criterion, said parameters comprise:
control field parameters comprising:
information on a subspace precoding tracking table formed using a precoding matrix codebook with pre-defined codewords for a precoding matrices of a selected size, and
data field parameters comprising:
a precoding matrix index for one cluster, said precoding matrix index defining a precoding matrix for said one cluster and being selected from said precoding matrix codebook,
one or more precoding matrix indexes for corresponding one or more further clusters, said one or more precoding matrix indexes defining preceding matrices for said one or more further clusters and being selected, using said information, from said subspace precoding tracking table by using a reduced number of codewords of said pre-defined codewords comprised in said subspace preceding tracking table; and
a preceding matrix defining module configured to generate said precoding matrices corresponding to said one cluster and to said one or more further clusters using said control field and data field parameters.

34. The transmitting component of claim 33, further comprising:
a precoder configured to define symbol vectors using said precoding matrices corresponding to said one cluster and said one or more further clusters using said control field and data field parameters; and
transmitting antennas configured to transmit said symbol vectors.

35. The transmitting component of claim 33, wherein a number of said one or more precoding matrix indexes equals to:
$$K = ⌊ \frac{{N}_{BR}}{{N}_{g}} ⌋ - 1 ,$$
wherein operator └x┘ rounds x towards −∞, i.e., integer such that x−1<└x┘≦x, N_{BR} is a total number of beamformed sub-carriers and N_{g} is a size of said one cluster and of the one or more further clusters, said N_{g} being defined by one or more beamformed sub-carriers of a plurality of beamformed sub-carriers.

36. The transmitting component of claim 33, wherein said control field parameters further comprise at least one of:
a selected size of the precoding matrices indicated by a number of columns and rows in said precoding matrices, and
a cluster size indicating a number of sub-carriers in each of said one cluster and said one or more further clusters, said number of sub-carriers being one or more sub-carriers out of a plurality of beamformed sub-carriers.

37. The transmitting component of claim 33, wherein said information on the subspace preceding tracking table comprises at least one of: a subspace tracking size and an index of said subspace preceding tracking table.

38. The transmitting component of claim 33, wherein said control field parameters further comprise an identification of a precoding matrix codebook, said identification being at least one of: a size of said precoding matrix codebook and an index of said precoding matrix codebook.
